(19) United States
(12) Patent Application Publication
(10) Pub. No.: US 2011/0043424 A1
(43) Pub. Date: Feb. 24, 2011

(54) BOARD-SHAPED WIDEBAND DUAL POLARIZATION ANTENNA

(75) Inventors: Jae Doo Lee, Hwaseong-si (KR); Jung Ho Kim, Hwaseong-si (KR); Sang Jin Kim, Hwaseong-si (KR)

Correspondence Address: LRK Patent Law Firm, 1952 Gallows Rd, Suite 200, Vienna, VA, 22182, US

(73) Assignee: GAMMA NU, INC., Hwaseong-si (KR)

(21) Appl. No.: 12/921,157

(22) PCT Filed: Jan. 13, 2009
(86) PCT No.: PCT/KR09/00166

§ 371 Date: Sep. 7, 2010

(30) Foreign Application Priority Data
Mar. 6, 2008 (KR) 10-2008-0020844

(51) Int. Cl. H01Q 21/29; H01Q 1/50

(52) U.S. Cl. 343/816; 343/906

(57) ABSTRACT

This invention relates to a board-shaped wideband dual polarization antenna whose feeding structure is simplified. Dipole antennas are prepared on both front and rear surfaces of a printed circuit board, and an electric signal is fed to the dipole antennas through via holes at the same time. Through the dipole antennas, the dual polarization antenna radiates dual polarized waves whose radiation emissions have perpendicular directions to each other. The wideband characteristics of the dual polarization antenna are improved through parasitic elements. The disclosed printed circuit board comprises: a first line hole into which a first core line (+) of a first electric cable transmitting a first electric signal is inserted; a first ground via hole through which a first ground line (−) of the first electric cable passes; a first balun hole into which a first balun cable is inserted; a second line hole into which a second core line (+) of a second electric line is inserted; is second balun hole into which a second balun cable is inserted; and a connection via-hole through which both the second core line (+) and the second balun cable pass. The first and second balun cables make a pair with the first and second electric cables respectively by being parallel to those electric cables respectively in order so perform the function of a balun. According to the invention, the dual polarization antenna is able to radiate, through the dipole antennas on both surfaces of the printed circuit boards, dual polarized waves whose radiation emissions have perpendicular directions to each other. In addition, the feeding structure can be simplified and a complex three-dimensional air-bridge structure does not need to be used in the dual polarization antenna since an electric signal is fed to the dipole antennas on both surfaces of the printed circuit board at the same time.

### BACKGROUND OF THE INVENTION

1. Field of the Invention

The present invention relates to a board-type wideband dual polarization dipole antenna used in a base station and a repeater of a mobile communication system or a wireless communication system.

2. Description of the Related Art

In general, a dual polarization antenna as an antenna having two polarized waves of an inclined angle in comparison with a general antenna having a single polarized wave such as a vertical polarized wave or a horizontal polarized wave is used as an antenna for implementing the duplication of a reception path of a base station in a mobile communication system.

The dual polarization antenna is used as an alternative for preventing communication deterioration by a fading phenomenon which is one of the largest causes to deteriorate communication quality instead of the existing spatial diversity antenna.

In the dual polarization antenna when a horizontal polarization antenna and a vertical polarization antenna are separately installed to separately synthesize signals, an influence of fading can be reduced and the spatial utilization of the dual polarization antenna is higher than the existing spatial diversity antenna and since two different antennas of the spatial diversity antenna can be configured in one antenna, it is possible to significantly save cost.

FIG. 1 is a plan view illustrating a known dual polarization wideband dipole antenna.

Referring to FIG. 1, the known wideband dipole antenna 100 includes a ground board 101, a feeding cable 103 and a balun cable 104 which each are mounted on the ground board 101, a radiator 102 where a plurality of radiation pattern portions 121a, 121b, 121c, and 121d are formed, which is connected with the feeding cable 103 and the balun cable 104, a radiation pattern portion connected with the feeding cable 103, an air bridge 123 connecting the radiation pattern portion connected with the balun cable 104, and a wideband compensation pad 125 which is etched onto the other surface of the radiator 102 to contribute to an increase of a bandwidth.

The feeding cable 103 and the balun cable 104 are connected with the radiator 102 through the ground board 101 and an outer peripheral surface thereof is soldered to a soldering connector 159 mounted on the ground board 101 to be grounded. The balun cable 104 forms a pair with the feeding cable 103 to implement a balun and the air bridge 123 as a metallic material electrically connects the radiation pattern portions 121a, 121b, 121c, and 121d which are formed on the radiator with the feeding cable 103.

The air bridge 123 made of the metallic material electrically connects a core line 131 of the feeding cable 103 to another radiation pattern which is positioned in a direction diagonal to the radiation pattern portion connected to a shell of the feeding cable 103. In order to prevent direct connection between the air bridge 123 and the radiation pattern portion connected to the shell of the feeding cable 103, a dielectric 105 exits on a feeding network in a predetermined height or more.

In the case of the known mobile communication system configured as described above, a radiating element as a metallic instrument is primarily etched on one surface of a planar board and a feeding structure has a 3D structure such as the air bridge 123.

Therefore, in the known dipole antenna structures, the feeding structure has a complicated shape through the air bridge and processability, and cost and workability is not good and as the radiation element is etched through one surface of the plane board, one polarized wave is radiated, such that there is a limit in improving wideband characteristics.

### SUMMARY OF THE INVENTION

In order to solve the above-mentioned problems, there is an object of the present invention to provide a board-type wideband dual polarization dipole antenna in which dipole antennas are provided on a front surface and a rear surface of a radiation board, electric power is fed to the dipole antennas on the front surface and the rear surface through a via hole, dual polarized waves whose antenna radiation directions are perpendicular (vertical) to each other are radiated through the dipole antennas on the front surface and the rear surface to simplify a feeding structure and improve wideband characteristics through parasite elements.

In order to achieve the above-mentioned object, an antenna radiation board according to an exemplary embodiment of the present invention includes: a first core line hole for inserting and connecting a first core line (+) of a first feed cable transferring a first feed signal; a first ground via hole for penetratively connecting a first ground line (−) of the first feed cable; a first balun hole for inserting and connecting a first balun cable which forms a pair with the first feed cable in parallel to serve as a balun; a second core line hole for inserting and connecting a second core line (+) of a second feed cable transferring a second feed signal; a second balun hole for inserting and connecting a second balun cable which forms a pair with the second feed cable to serve as the balun; and a core line balun connection via hole for penetratively connecting the second balun cable with the second core line (+).

Further, in order to achieve the above-mentioned object, in the antenna radiation board according to the exemplary embodiment of the present invention, dipole antennas are provided on a front surface and a rear surface and a feed signal is provided through a via hole of each dipole antenna at the same time.

At this time, parasite elements for extending a frequency band of each dipole antenna are provided on the front surface and the rear surface.

Meanwhile, in order to achieve the above-mentioned object, an antenna radiation board according to another embodiment of the present invention includes: a front part with a front dipole antenna radiating a first feed signal; a rear part with a rear dipole antenna radiating a second feed signal; a feeding part providing the first feed signal to the front part and providing the second feed signal to the rear part through a via hole; and a feed line unit transferring the first feed signal from the feeding part to the front dipole antenna and transferring the second feed signal to the rear dipole antenna.

Further, the feeding part includes: includes a front feeding part receiving the first feed signal and a rear feeding part receiving the second feed signal, and a first core line hole through which a first core line (+) of a first feed cable applying the first feed signal is penetratively connected from the rear feeding part; a first ground via hole to which a first ground line (−) of the first feed cable is penetratively connected from the rear feeding part; a first balun hole into which a first balun cable which forms a pair with the first feed cable to serve as a balun is inserted and connected; a second core line hole into which a second core line (+) of the second feed cable is inserted and connected; a second balun hole into which a second balun cable which forms a pair with the second feed cable to serve as the balun is inserted and connected; and a core line balun connection via hole for connecting the second balun cable with the second core line (+) by penetrating the front feeding part and the rear feeding part.

Further, the core line balun connection via hole and the second balun hole are connected to each other through a connection pattern, and the second feed signal applied to the second core line hole of the front feeding part by penetrating from the second core line hole of the rear feeding part is transferred to the core line balun connection via hole through the connection pattern and its transferred to the core line balun connection via hole of the rear feeding part by penetrating from the core line balun connection via hole of the front feeding part.

In addition, in the front feeding part, the first core line hole and the first balun hole are connected to each other through a first printed circuit pattern, and the first feed signal applied to the first core line hole of the front feeding part by penetrating the first core line hole from the rear feeding part is transferred to the first balun hole through the printed circuit pattern.

Moreover, parasite elements for extending frequency bands of the front dipole antenna and the rear dipole antenna are provided on the front part and the rear part.

Besides, the front dipole antenna radiates a polarized wave of +45° and the rear dipole antenna radiates a polarized wave of −45°.

Meanwhile, a board-type dual polarization dipole antenna according to yet another embodiment of the present invention includes: a first feed cable transferring a first feed signal; a fist balun cable which forms a pair with the first feed cable to serve as a balun; a second feed cable transferring the first feed signal and a second feed signal; a second balun cable which forms a pair with the second feed cable to serve as the balun; a support unit fixing and supporting the first feed cable and the first balun cable and the second feed cable and the second balun cable; and a radiation board in which the first feed cable and the first balun cable and the second feed cable and the second balun cable are inserted and connected and dipole antennas are provided on a front part and a rear part to radiate the first feed signal as a first polarized wave through the dipole antenna provided on the front part and radiate the second feed signal as a second polarized wave vertical to the first polarized wave through the dipole antenna provided on the rear part.

Further, the radiation board includes: a feeding part providing the first feed signal from the first feed cable to the front part and providing the second feed signal from the second feed cable to the rear part; and a feed line unit transferring the first feed signal from the feeding part to the dipole antenna provided on the front part and transferring the second fed signal to the dipole antenna provided on the rear part.

In addition, the feeding part includes: a first core line hole through which a first core line (+) of the first feed cable is inserted and connected; a first ground via hole to which a first ground line (−) of the first feed cable is penetratively connected; a first balun hole into which a first balun cable which forms a pair with the first feed cable to serve as a balun is inserted and connected; a second core line hole into which a second core line (+) of the second feed cable is inserted and connected; a second balun hole into which a second balun cable which forms a pair with the second feed cable to serve as the balun is inserted and connected; and a core line balun connection via hole for connecting the second balun cable with the second core line (+) by penetrating the front part and the rear part.

Moreover, on the front part of the radiation board, the first core line hole and the first balun hole are connected to each other through a first printed circuit pattern, the second core line hole and the core line balun connection via hole are connected to each other by a connection pattern, and on the rear part of the radiation board, the core line balun connection vie hole and the second balun hole are connected to each other by a second printed circuit pattern.

Besides, on the front part, the first feed signal is transferred from the first core line hole to the first balun hole through the first printed circuit pattern and is transferred to the dipole antenna provided on the front part from the first balun hole through the feed line unit.

Further, on the rear part, the second feed signal penetrates from the second core line hole to be transferred to the second core line hole of the front part, is transferred to the core line balun connection via hole of the front part from the second core line hole of the front part through the connection pattern, penetrates from the core line balun connection via hole of the front part to be transferred to a core line balun connection via hole of the rear part, is transferred to the second balun hole from the core line balun connection via hole through the second printed circuit pattern, and is transferred to the dipole antenna provided on the rear part from the second balun hole through the feed line unit.

In addition, on the radiation board, parasite elements for extending frequency bands of the dipole antenna provided on the front part and the dipole antenna provided on the rear part are provided on the front part and the rear part.

[symbol]

According to an embodiment of the present invention, it is possible to radiate dual polarized waves whose radiation directions are perpendicular (vertical) to each other through dipole antennas which are positioned on both surfaces of a radiation board and since electric power is fed to both dipole antennas which are positioned on both surfaces through via holes, it is possible to simplify a feeding structure of the dipole antenna.

Further, since electric power is fed to both dipole antennas which are positioned on both surfaces of the radiation board through the via holes, it is not necessary to use a complicated 3D air bridge structure.

In addition, it is possible to wideband characteristics of a radiation signal by using a parasite element of the radiation board.

### BRIEF DESCRIPTION OF THE DRAWINGS

FIG. 1 is a plan view illustrating a known dual polarization wideband dipole antenna.

FIG. 2 is a plan view illustrating the configuration of an antenna radiation board according to an exemplary embodiment of the present invention.

FIG. 3 is a diagram illustrating the configuration of a front part and a feeding structure on an antenna radiation board according to an exemplary embodiment of the present invention.

FIG. 4 is a diagram illustrating the configuration of a rear part and a feeding structure on an antenna radiation board according to an exemplary embodiment of the present invention.

FIG. 5 is a plan view illustrating an operation of front part of an antenna radiation board according to an exemplary embodiment of the present invention.

FIG. 6 is a diagram illustrating an operation of a rear part of an antenna radiation board according to an exemplary embodiment of the present invention.

FIG. 7 is a configuration diagram illustrating the configuration of a board-type wideband duel polarization dipole antenna according to an exemplary embodiment of the present invention.

FIG. 8 is a diagram illustrating a board-type wideband dual polarization dipole antenna array according to an exemplary embodiment of the present invention.

FIG. 9 is a graph illustrating a VSWR measurement result of a board-type wideband dual polarization dipole antenna according to an exemplary embodiment of the present invention.

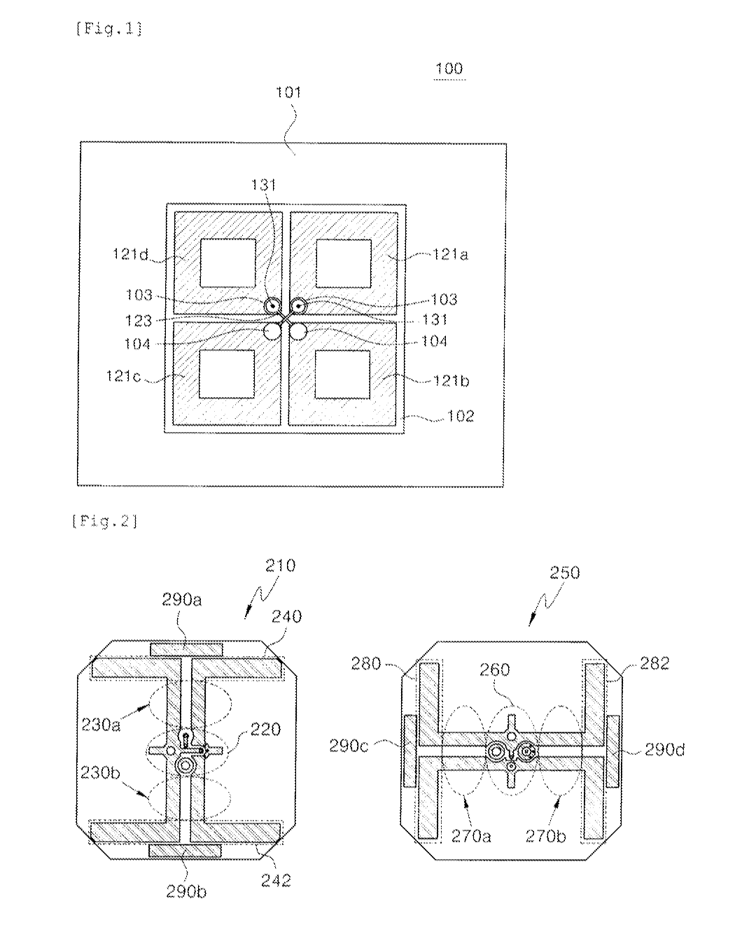

### DETAILED DESCRIPTION OF THE PREFERRED EMBODIMENTS

A matter regarding to a configuration and an effect of the present invention will be appreciated clearly through the following detailed description with reference to the accompanying drawings illustrating preferable embodiments of the present invention. Hereinafter, an embodiment in accordance with the present invention will be described in detail with reference to the accompanying drawings.

FIG. 2 is a plan view illustrating the configuration of an antenna radiation board according to an exemplary embodiment of the present invention.

As a result, a front feeding part 220 and a rear feeding part 260 receive a first feed signal and a second feed signal to feed the received signals to dipole antennas 240, 242, 280, and 282 through parallel feed line units 230 and 270 at the same time.

Herein, a feed cable includes a first feed cable applying the first feed signal to the front feeding part 220 and a second feed cable applying the second feed signal to the rear feeding part 260. The first feed cable and the second feed cable may be implemented by, for example, a coaxial cable in order to transfer electric power or a signal and is constituted by an internal conductor (core line) serving as a signal line and an external conductor serving as a ground line.

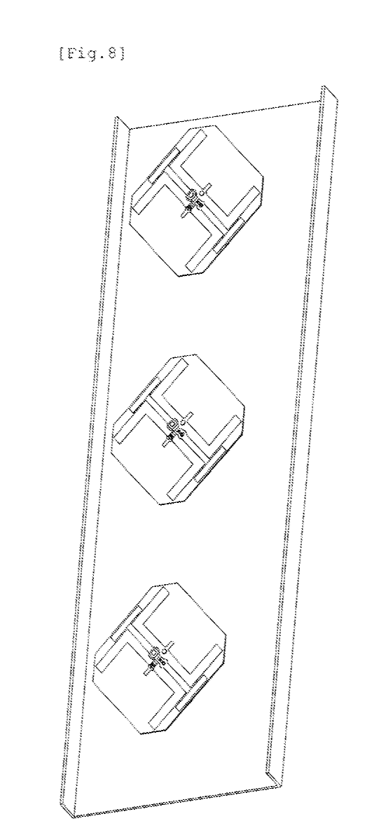

Meanwhile, although described in FIG. 7 to be shown later, a first balun cable which forms a pair with the first feed cable in parallel and a second balun cable which forms the second feed cable in parallel are inserted into and connected to the rear feeding part 260. At this time, the first balun cable and the second balun cable serve as a balun with respect to the first feed cable and the second feed cable. Herein, the role of the balun (BALUN:Balance/Unbalance), which is a concept to allow resonance to be made by balancing a difference between a (+) feed signal and a (−) feed signal of the first feed cable and the second feed cable, is a known technology in an antenna field.

The parallel feed line units 230 and 270 transfer the feed signals applied from the feeding parts 220 and 260 to the dipole antennas 240, 242, 280, and 282.

Further, the parallel feed line units 230 and 270 has a function of converting impedance of the feeding parts 220 and 260 into impedances of the dipole antennas 240, 242, 280, and 282 and therefore, may be referred to as an impedance converting unit.

The dipole antennas 240, 242, 280, and 282 radiates the feed signals from the feeding parts 220 and 260 through the parallel feed line units 230 and 270 to free space.

At this time, the dipole antennas 240, 242, 280, and 282 are constituted by front dipole antennas 240 and 242 that are provided on a front part 210 and rear dipole antennas 280 and 282 that are provided on a rear part 250.

Herein, the front dipole antennas 240 and 242 are constituted by a first front dipole antenna 240 and a second front dipole antenna 242 for radiating the first feed signal and the rear dipole antennas 280 and 282 are constituted by a third rear dipole antenna 280 and the fourth rear dipole antenna 282 for radiating the second feed signal.

Further, the parallel feed line units 230 and 270 are constituted by a front parallel feed line unit 230 transferring the first feed signal from the front feed unit 220 to the front dipole antennas 240 and 242 and a rear parallel feed line unit 270 transferring the second feed signal from the rear feed unit 260 to the rear dipole antennas 280 and 282.

Herein, the front parallel feed line unit 230 is constituted by a first front parallel feed line portion 230a transferring the first feed signal from the front feed unit 220 to the first front dipole antenna 240 and a second front parallel feed line portion 230b transferring the first feed signal to the second front dipole antenna 242. Further, the rear parallel feed line unit 270 is constituted by a third rear parallel feed line portion 270a transferring the second feed signal from the rear feed unit 260 to the third rear dipole antenna 288 and a fourth rear parallel feed line portion 270b transferring the second feed signal to the fourth rear dipole antenna 282.

In addition, the first front dipole antenna 240 and the second front dipole antenna 242 and the third rear dipole antenna 280 and the fourth rear dipole antenna 282 have a length of a wavelength (λ) of ½ and are spaced apart from the feeding parts 220 and 260 by a wavelength (λ) of ¼. Therefore, the front parallel feed line unit 230 and the rear parallel feed line unit 270 have a length of the wavelength (λ) of ¼.

In the antenna radiation board 200 configured as described above, the first feed cable and the second feed cable and the first balun cable and the second balun cable are connected to the rear feeding part 260, and the second feed signal by the second feed cable is applied to the rear feeding part 260 and the first feed signal by the first feed cable is applied to the front feeding part 220 from the rear feeding part 260 through via holes at the same time.

Subsequently, the first feed signal is transferred to the front dipole antennas 240 and 242 from the feeding part 220 through the front parallel feeding line unit 230 and the second feed signal to the rear dipole antennas 280 and 282 from the rear feeding part 260 through the rear parallel feed line unit 270 at the same time.

Therefore, as the front dipole antennas 240 and 242 radiate the first feed signal as a polarized wave of +45° and at the same time, the rear dipole antennas 280 and 282 radiate the second feed signal as a polarized wave of −45°, the antenna radiation board 200 radiates dual polarized waves which are perpendicular (vertical) to each other through the front part 210 and the rear part 250.

FIG. 3 is a diagram illustrating the configuration of a front part and a feeding structure on an antenna radiation board according to an exemplary embodiment of the present invention.

Referring to FIG. 3, the front part 210 includes the front feeding part 220 receiving the first feed signal from the outside, the front parallel feed line unit 230 transferring the first feed signal to the front dipole antennas 240 and 242 from the front feeding part 220, front dipole antennas 240 and 242 radiating the first feed signal to space, and front parasite elements 290a and 290b for extending frequency bands of the front dipole antennas 240 and 242.

Herein, the front feeding part 220 includes a first core line hole 310 through which a first core line (+) of the first feed cable is penetrated and connected from the rear feeding part 260, a first ground via hole 312 through which a first ground line (−) of the first feed cable is penetrated and connected form the rear feeding part 260, a first balun hole 314 through which the first balun which forms a pair with the first feed cable to serve as the balun is inserted and connected, a second core line hole 316 through which a second core line (+) of the second feed cable is inserted and connected, a second balun hole 318 through which the second balun cable forms a pair with the second feed cable to serve as the balun is inserted and connected, and a core line balun connection via hole 320 for connecting the second core line (+) and the second balun cable by penetrating the front feeding part 220 and the rear feeding part 260.

Further, the first core line hole 310 and the first balun hole 314 are connected to each other through a first printed circuit pattern 322 and the second core line hole 316 and the core line balun connection via hole 320 are connected to each other through a connection pattern 324.

The front dipole antennas 240 and 242 include the first front dipole antenna 240 and the second front dipole antenna 242 radiating the first feed signal as a polarized wave of +45°. Herein, the first front dipole antenna 240 is positioned spaced apart upwardly from the front feeding part 220 by the wavelength (λ) of ¼ and the second front dipole antenna 242 is positioned apart downwardly from the front feeding part 220 by the wavelength (λ) of ¼.

Further, in the front parallel feed line unit 230, two feed lines for transferring (+) current and (−) current to the front dipole antennas 240 and 242 from the front feeding part 220 are arranged in parallel.

At this time, the front parallel feed line unit 230 matches impedances of the front feeding part 220 and the front dipole antennas 240 and 242. That is, although there is a bit difference between the impedance of the front feeding part 220 and the impedances of the front dipole antennas 240 and 242, the front parallel feed line unit 230 converts the impedance of the front feeding part 220 into the impedances of the front dipole antennas 240 and 242 while the first feed signal is transferred to the front dipole antennas 240 and 242 from the front feeding part 220 through the front parallel feed line unit 230.

Meanwhile, the first core line (+) of the first feed cable is inserted into and connected to the first core line hole 310 of the rear feeding part 260 to penetrate the first core line hole 310 and get out through the first core line hole 310 of the front feeding part 220. At this time, the first ground line (−) is connected to a first ground via hole 312 of the rear feeding part 260. Herein, the first ground via hole 312 is constituted by three holes, but may be properly constituted by one or more holes in accordance with an intention of a designer.

Therefore, the (+) current is applied to the first core line hole 310 from the first feed cable and the (−) current is applied to the first ground via hole 312.

As a result, on the front part 210, the (−) current of the ground via hole 312 is also applied to the front parallel feed line portions 230a and 230b while the (+) current of the first core line hole 310 is applied to the front parallel feed line portions 230a and 230b through the first printed circuit pattern 322 and the first balun hole 314, such that the applied feed signals are transferred to both the first front dipole antenna 240 and the second front dipole antenna 242 through the front parallel feed line portions 230a and 230b.

Meanwhile, on the front part 210 of FIG. 3, a first circular circuit pattern 326 which circularly surrounds the second balun hole 318 is spaced apart from the second front parallel feed line portion 230b at predetermined intervals.

Further, in the first front dipole antenna 240, an antenna constituent member 240a which receives the (+) current and an antenna constituent member 240b which receives the (−) current are horizontally symmetric to each other and even in the second front dipole antenna 242, an antenna constituent member 242a which receives the (+) current and an antenna constituent member 242b which receives the (−) current are horizontally symmetric to each other.

In contrast, the first front dipole antenna 240 and the second front dipole antenna 242 are vertically symmetric to each other on the basis of the front feeding part 220.

Further, on the front part 210, the front parasite elements 290a and 290b are arranged in parallel to the first front dipole antenna 240 and the second front dipole antenna 242, current having the same direction as current directions of the first front dipole antenna 240 and the second front dipole antenna 242 is induced to serve to extend frequency bandwidths of the first front dipole antenna 240 and the second front dipole antenna 242.

In the case of the front part 210 configured as described above, the first core line (+) of the first feed cable is inserted into and connected to the first core line hole 310 of the rear feeding part 260 to penetrate the first core line hole 310 to be connected to the first core line hole 310 of the front feeding part 220. Therefore, the (+) current is applied to the first balun hole 314 from the first core line hole 211 of the front feeding part 220 through the first printed circuit pattern 322 and the (+) current applied to the first balun hole 314 is transferred to the first front dipole antenna 240 and the second front dipole antenna 242 through the front parallel feed line portions 230a and 230b.

At the same time, on the front part 210, the first ground line (−) of the first feed cable is connected to the first ground via hole 312 of the rear feeding part 260 and the first ground line (−) is connected to the first ground via hole 312 of the front feeding part 220 through the first ground via hole 312.

Therefore, the (−) current is transferred to the first front dipole antenna 240 and the second front dipole antenna 242 from the first ground via hole 312 of the front feeding part 220 through the front parallel feed line portions 230a and 230b.

Accordingly, the first front dipole antenna 240 and the second front dipole antenna 242 radiate the first feed signal to free space as the polarized wave of +45°.

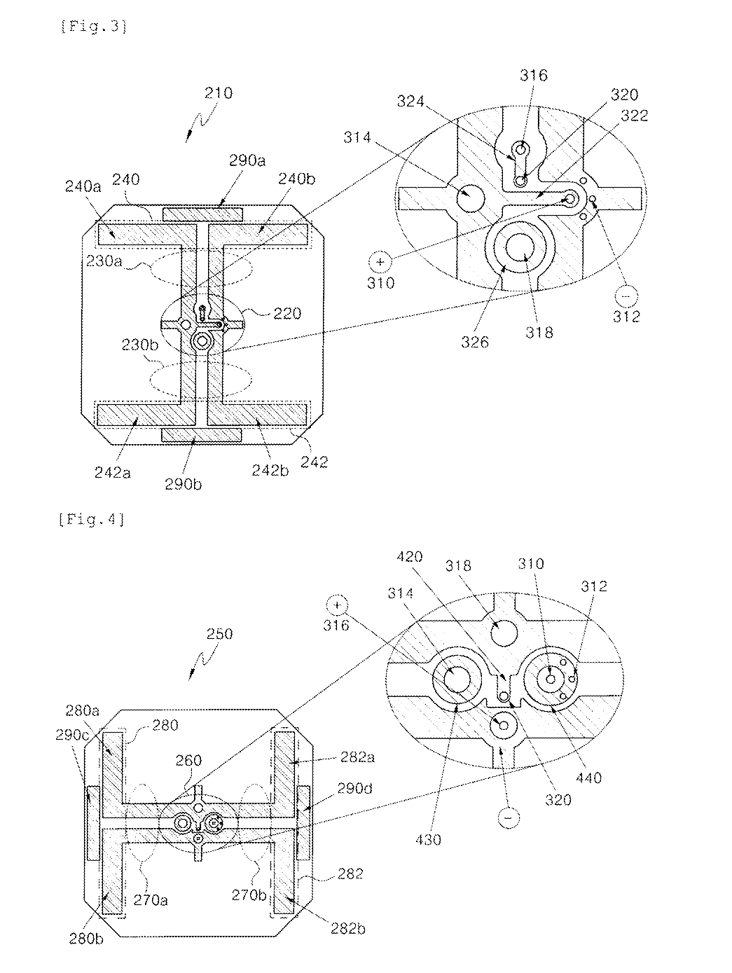

FIG. 4 is a diagram illustrating the configuration of a rear part and a feeding structure on an antenna radiation board according to an exemplary embodiment of the present invention.

Referring to FIG. 4, the front part 250 according to the exemplary embodiment of the present invention includes the rear feeding part 260 receiving the second feed signal from the outside, the rear parallel feed line unit 270 transferring the second feed signal from the rear feeding part 260 to the rear dipole antennas 280 and 282, the rear dipole antennas 280 and 282 radiating the second feed signal received from the rear parallel feed line unit 270 to the free space, and the rear parasite elements 290c and 290d for widening the bandwidth of the second feed signal.

Herein, the rear feeding part 260 includes a second core line hole 316 for inserting a second core line (+) of the second feed cable, a second balun hole 318 for inserting and connecting the second balun cable which forms a pair with the second feed cable to serve as the balun, a core line balun connection via hole 320 for connecting the second balun cable with the second core line (+) inserted into the second core line hole 316, a first core line hole 310 into which the first core line (+) of the first feed cable is inserted, a first ground via hole 312 connecting the first ground line (−) of the first feed cable, and a first balun hole 314 for inserting and connecting the first balun cable which forms a pair with the first feed cable to serve as the balun.

At this time, the second balun hole 318 and the core line balun connection via hole 320 are connected to a second printed circuit pattern 420 and the second core line hole 316 is spaced apart from a part which contacts the second ground line (−) of the second feed cable by predetermined intervals.

Further, the rear dipole antennas 280 and 282 include the first rear dipole antenna 280 and the second rear dipole antenna 282 which radiate the second feed signal as the polarized wave of −45°. Herein, the first rear dipole antenna 280 is positioned spaced apart to the left from the rear feeding part 260 by the wavelength (λ) of ¼ and the second rear dipole antenna 282 is positioned apart to the right from the rear feeding part 260 by the wavelength (λ) of ¼.

Further, in the rear parallel feed line unit 270, two feed lines for transferring the (+) current and the (−) current to the rear dipole antennas 280 and 282 from the rear feeding part 260 are arranged in parallel.

In addition, the rear parallel feed line unit 270 matches impedances of the rear feeding part 260 and the rear dipole antennas 280 and 282. That is, although there is a bit difference between the impedance of the rear feeding part 260 and the impedances of the rear dipole antennas 280 and 282, the rear parallel feed line unit 270 converts the impedance of the rear feeding part 260 into the impedances of the rear dipole antennas 280 and 282 while the second feed signal is transferred to the rear dipole antennas 280 and 282 from the rear feeding part 260 through the rear parallel feed line unit 270.

Meanwhile, the second core line (+) of the second feed cable is inserted into and connected to the second core line hole 316 of the rear feeding part 260 and the second ground line (−) is spaced apart from the second core line hole 316 by a predetermined gap to contact a part which is connected with the rear parallel feed line unit 270. Therefore, the (+) current is applied to the second core line hole 316 from the second feed cable and the (−) current is applied to the part connected with the rear parallel feed line unit 270.

As a result, on the rear part 250, the (−) current of the second ground line is applied to the rear parallel feed line portions 270a and 270b while the (−) current of the second core line hole 316 is applied to the rear parallel feed line portions 270a and 270b through the connection pattern 324 and the core line balun connection via hole 320 of the front feeding part 220 and the second printed circuit pattern 420 and the second balun hole 318 of the rear feeding part 260, such that the applied feed signals are transferred to both the third rear dipole antenna 280 and the fourth rear dipole antenna 282 through the rear parallel feed line portions 270a and 270b.

Accordingly, the third rear dipole antenna 280 and the fourth rear dipole antenna 282 radiate the second feed signal to the free space as the polarized wave of −45°.

Meanwhile, on the rear part 250 of FIG. 4, a second circular circuit pattern 430 which circularly surrounds the first balun hole 314 is spaced apart from the first rear parallel feed line portion 270a at predetermined intervals. Further, a third circular circuit pattern 440 which circularly surrounds one or more first ground via holes 312 which are spaced apart from the first core line hole 310, and the like at predetermined intervals is spaced apart from the second rear feed line portion 270b at predetermined intervals.

Further, in the third rear dipole antenna 280, an antenna constituent member 280a which receives the (+) current and an antenna constituent member 280b which receives the (−) current are vertically symmetric to each other and even in the fourth rear dipole antenna 282, an antenna constituent member 282a which receives the (+) current and an antenna constituent member 282b which receives the (−) current are vertically symmetric to each other.

In contrast, the first rear dipole antenna 280 and the second rear dipole antenna 282 are horizontally symmetric to each other on the basis of the rear feeding part 260.

Further, on the rear part 250, the rear parasite elements 290c and 290d are arranged in parallel to the third rear dipole antenna 280 and the fourth rear dipole antenna 282, current having the same direction as current directions of the third rear dipole antenna 280 and the fourth rear dipole antenna 282 is induced to serve to extend frequency bandwidths of the third rear dipole antenna 280 and the fourth rear dipole antenna 282 by the induced current.

On the rear part 280 configured as described above, as the second core line (+) of the second feed cable is inserted into and connected to the second core line hole 316, the (+) current penetrates from the second core line hole 316 to be transferred to the second core line hole 316 of the front feeding part 220, is transferred to the core line balun connection via hole 320 through the connection pattern 324 in the second core line hole 316 of the front feeding part 220, penetrates from the core line balun connection via hole 320 to be transferred to the core line balun connection via hole 320 of the rear feeding part 260, and is applied to the second balun hole 318 from the core line balun connection via hole 320 through the second printed circuit pattern 420 in the rear feeding part 260, and the (+) current applied to the second balun hole 318 is transferred to the third rear dipole antenna 280 and the fourth rear dipole antenna 282 through the rear parallel feed line portions 270a and 270b, respectively.

At the same time, the (−) current is transferred to the third rear dipole antenna 280 and the fourth rear dipole antenna 282 from the second ground line (−) of the second feed cable through the rear parallel feed line portions 270a and 270b.

Accordingly, the third rear dipole antenna 280 and the fourth rear dipole antenna 282 radiate the second feed signal to the free space as the polarized wave of −45°.

FIG. 5 is a plan view illustrating an operation of a front part of an antenna radiation board according to an exemplary embodiment of the present invention.

Referring to FIG. 5, on the front cart 210 of the antenna radiation board 200 according to the exemplary embodiment of the present invention, since the first core line (+) of the first feed cable penetrates from the first core line hole 310 of the rear feeding part 260 to be connected to the first core line hole 310 of the front feeding part 220, the (+) current is applied to the first balun hole 314 from the first core line hole 310 of the front feeding part 220 through the first printed circuit pattern 322 and is transferred to the first front dipole antenna 240 and the second front dipole antenna 242 through the front parallel feed line unit 230 in the first balun hole 314. Therefore, the (+) current has a current direction which faces the front dipole antennas 240 and 242 from the first balun hole 314 of the front feeding part 220 through the front parallel feed line unit 230.

At the same time, the first ground line (−) of the first feed cable penetrates from the first ground via hole 312 of the rear feeding part 260 to be connected to the first ground via hole 312 of the front feeding cart 220, such that the (−) current is transferred to the front dipole antennas 240 and 242 from the first ground via hole 312 through the front parallel feed line unit 230 to have a direction of current which flows into the first ground via hole 312 from the front dipole antennas 240 and 242 through the front parallel feed line unit 230.

Meanwhile, the front parallel feed line unit 230 is connected the centers of the front dipole antennas 240 and 242.

As a result, since the (+) current is applied to the centers of the dipole antennas 240 and 242 from the front parallel feed line unit 230 and the (−) current is transferred to the front parallel feed line unit 230 from the centers of the front dipole antennas 240 and 242, the front dipole antennas 240 and 242 have a direction of current which flows from the right side to the left side as shown in FIG. 5.

At this time, on the front part 210, the front parasite elements 290a and 290b which are spaced part from the front dipole antennas 240 and 242 at predetermined intervals are arranged in parallel to the front dipole antennas 240 and 242.

Therefore, the current is induced, which flows from the right side to the left side in the same manner as the current direction of the front dipole antennas 240 and 242 even in the front parasite elements 290a and 290b which are arranged in parallel to the front dipole antennas 240 and 242. Herein, frequency bandwidths of the front dipole antennas 240 and 242 are extended by the current induced to the front parasite elements 290a and 290b.

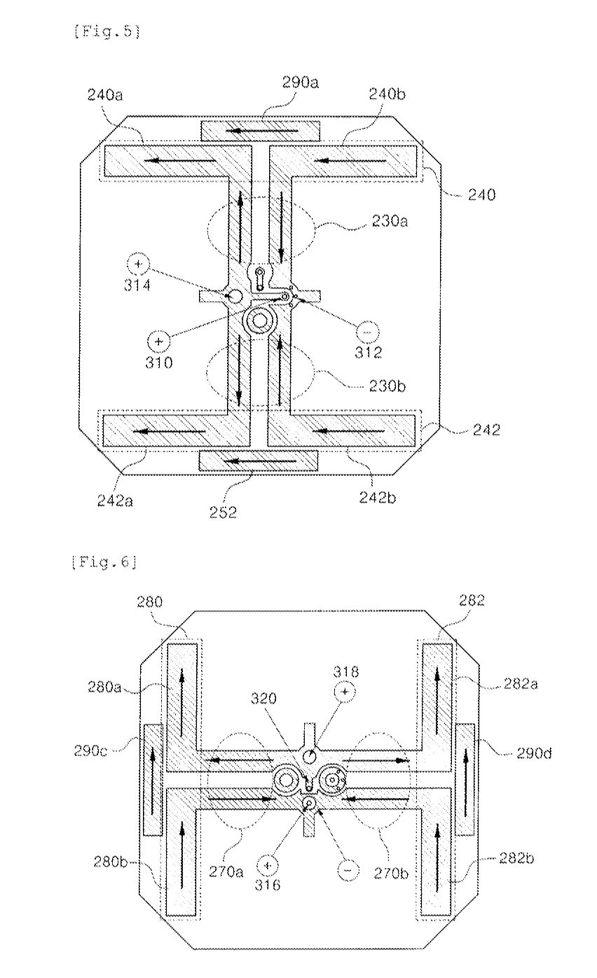

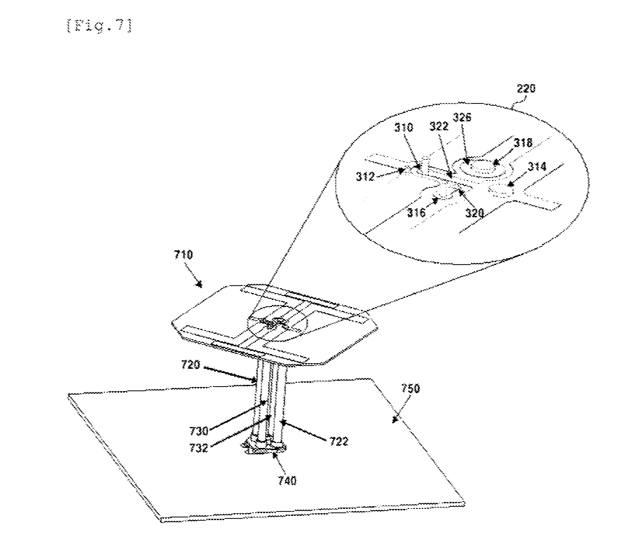

FIG. 6 is a diagram illustrating an operation of a rear part of an antenna radiation board according to an exemplary embodiment of the present invention.

Referring to FIG. 6, on the rear part 250 of the antenna radiation board 200 according to the exemplary embodiment of the present invention, the second core line (+) of the second feed cable penetrates from the second core line hole 316 of the rear feeding part 260 to be connected to the second core line hole 316 of the front feeding part 220, is transferred to the core line balun connection via hole 320 through the connection pattern 324 in the second core line hole 316 of the front feeding part 220, penetrates from the core line balun connection via hole 320 of the front feeding part 220 to be transferred to the core line balun connection via hole 320 of the rear feeding part 260, and is applied to the second balun hole 318 from the core line balun connection via hole 320 through the second printed circuit pattern 420 in the front feeding part 260, and the (+) current applied to the second balun hole 318 is transferred to the third rear dipole antenna 280 and the fourth rear dipole antenna 282 through the rear parallel feed line portions 270a and 270b, respectively.

Therefore, on the rear part 250, the (+) current has a current direction which faces the rear dipole antennas 280 and 282 from the second balun hole 318 of the rear feeding part 260 through the rear parallel feed line unit 270.

At the same time, since the (−) current is transferred to the rear dipole antennas 280 and 282 from the second ground line (−) of the second feed cable through the rear parallel feed line unit 270, the (−) current has a direction of current which flows into the second core line hole 316 from the rear dipole antennas 280 and 282 through the rear parallel feed line unit 270.

Meanwhile, the front parallel feed line unit 270 is connected the centers of the front dipole antennae 280 and 282.

As a result, since the (+) current is applied to the centers of the dipole antennas 280 and 282 from the rear parallel feed line unit 270 and the (−) current is transferred to the rear parallel feed line unit 270 from the centers of the rear dipole antennas 280 and 282, the rear dipole antennas 280 and 282 have a direction of current which flows from the lower side to the upper side as shown in FIG. 6.

At this time, on the rear part 210, the rear parasite elements 290c and 290d which are spaced part from the rear dipole antennas 280 and 282 at predetermined intervals are arranged in parallel to the rear dipole antennas 280 and 282.

Therefore, the current is induced, which flows from the lower side to the upper side in the same manner as the current direction of the rear dipole antennas 280 and 282 even in the rear parasite elements 290c and 290d which are arranged in parallel to the rear dipole antennas 280 and 282. Herein, the frequency bandwidths of the front dipole antennas 280 and 282 are extended by the current induced to the rear parasite elements 290c and 290d.

FIG. 7 is a configuration diagram illustrating the configuration of a board-type wideband dual polarization dipole antenna according to an exemplary embodiment of the present invention.

Referring to FIG. 7, the board-type wideband dual polarization dipole antenna 700 according to the exemplary embodiment of the present invention includes a radiation board 710, a first feed cable 720, a first balun cable 722, a second feed cable 730, a second balun cable 732, a support unit 740, and a ground board 750.

The radiation board 710 is constituted by the front part 210 and the rear part 250 as described through FIGS. 2 to 4 and in FIG. 7, the front part 210 of the radiation board 710 is shown. Herein, since the configuration of the front part 210 is described through FIGS. 2 and 3, the configuration will not be described.

As shown in FIG. 7, the front feeding part 220 includes a first core line hole 310 where a first core line (+) of the first feed cable 720 is inserted into and connected the rear feeding part 260 to penetrate the front feeding part 220, a first ground via hole 312 where a first ground line (−) of the first feed cable 720 is connected to the rear feeding part 260 penetrate the front feeding part 220 from the rear feeding part 260, a first balun hole 314 for inserting and connecting a first balun cable 722 which forms a pair with the first feed cable 720 to serve as the balun, a second core line hole 316 for inserting and connecting a second core line (+) of the second feed cable 730, a second balun hole 318 for inserting and connecting a second balun cable 732 which forms a pair with the second feed cable 730 to serve as the balun, and a core line balun connection via hole 320 for penetratively connecting the second balun cable with the second core (+) of the second feed cable 730.

In FIG. 7, the first feed cable 720 transfers a first feed signal of (+) current received from the outside through the first core line (+) to the first core line hole 310.

The first balun cable 722 forms a pair with the first feed cable 720 to serve as the balun, and is inserted into and connected to the first balun hole 314.

The second feed cable 730 transfers a second feed signal of (+) current received from the outside through the second core line (+) to the second core line hole 316.

The second balun cable 732 forms a pair with the second feed cable 730 to serve as the balun, and is inserted into and connected to the second balun hole 318.

The core line balun connection via hole 320 is a via hole where when the second core line (+) of the second feed cable 730 inserted into the second core line hole 316 of the rear feeding part 260 penetrates from the second core line hole 316 of the rear feeding part 260 to be connected to the second core line hole 316 of the front feed unit 220, the second core line (+) of the second feed cable 730 is connected with the second core line hole 316 of the front feeding part 220 through the connection pattern 324 and connected to the second balun hole 318 of the rear feeding part 260 through the second printed circuit pattern 420 of the rear feeding part 260 to connect the second balun cable 732 with the second core line (+) of the second feed cable 730.

At this time, on the front feeding part 220, the first core line hole 310 and the first balun hole 314 are connected to each other through the first printed circuit pattern 322.

Meanwhile, the first feed cable 720 and the first balun cable 722 and the second feed cable 730 and the second balun cable 732 are supported and fixed to the support unit 740 by soldering, and the like.

The antenna having the dipole structure essentially requires an additional structure called the balun for balancing the impedances of the (+) feed signal and the (−) feed signal at the time of feeding through the coaxial line due to its symmetric structure. Therefore, the first feed cable 720 and the first balun cable 722 and the second feed cable 730 and the second balun cable 732 are fixed to the support unit 740 which is made of a metallic material by soldering to be installed to be grounded while being balanced with each other, thereby forming the balun structure. Herein, each of the first feed cable 720 and the second feed cable 730 may be configured by using the coaxial cable.

The support unit 740 may be stably coupled to the ground board 750 which is made of a conductive material by using, for example, a bolt-nut structure, and the like while the first feed cable 720 and the first balun cable 722 and the second feed cable 730 and the second balun cable 732 connected to the radiation board 710 are fixed by soldering.

The first feed cable 720 and the first balun cable 722 are parallel to each other and the second feed cable 730 and the second balun cable 732 are fixed to the support unit 740 to be are parallel to each other.

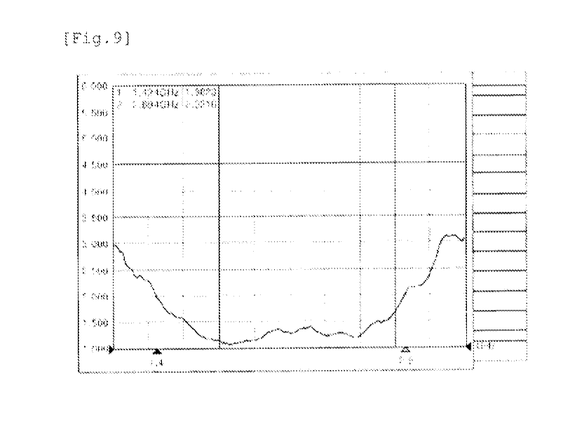

Meanwhile, in the board-type wideband dual polarization dipole antenna 700 according to the exemplary embodiment of the present invention, a plurality of antenna arrays may be designed on the ground board 750 which is made of the conductive material as shown in FIG. 8. FIG. 8 is a diagram illustrating a board-type wideband dual polarization dipole antenna array according to an exemplary embodiment of the present invention.

FIG. 9 is a graph illustrating a VSWR measurement result of a board-type wideband dual polarization dipole antenna according to an exemplary embodiment of the present invention.

Referring to FIG. 9, the board-type wideband dual polarization dipole antenna 700 according to the exemplary embodiment of the present invention may use a wide frequency band in the range of 1.2 GHz to 3 GHz on the basis of a result of measuring a voltage standing wave ratio (VSWR) by implementing the dipole antenna on the front surface and the rear surface as a printed circuit board type.

Therefore, the board-type wideband dual polarization dipole antenna 700 according to the exemplary embodiment of the present invention may use a wideband frequency of approximately 1750 to 1600 MHz including a PCS frequency band of 1750 to 1860 MHz, a USPCS frequency band of 1850 to 1960 MHz, a GSM frequency band of 1710 to 1800 MHz, a WCDMA frequency band of 1920 to 2170 MHz, a Wibro frequency band of 2300 to 2390 MHz, and a WiMAX frequency band of 2400 to 2500 MHz.

As described above, according to the present invention, it is possible to implement the board-type wideband dual polarization dipole antenna in which the dipole antenna is provided on the front surface and the rear surface of the radiation board, electric power is fed to the dipole antennas on the front surface and the rear surface through the via hole, dual polarized waves whose antenna radiation directions are perpendicular (vertical) to each other are radiated through the dipole antennas on the front surface and the rear surface to simplify the feeding structure and improve wideband characteristics through the parasite elements.

While certain embodiments have been described above, it will be understood to those skilled in the art that the embodiments described are by way of example only.

Rather, the apparatus described herein should only be limited in light of the claims that follow when taken in conjunction with the above description and accompanying drawings.

The present invention can be used in a base station antenna of a mobile communication system and can be applied to a dual polarization dipole antenna which radiates or receives a wireless signal. Further, the present invention can also be applied to a dual polarization antenna whose radiation directions of the dipole antenna are perpendicular to each other.

What is claimed is:

1. An antenna radiation board, comprising:
a first core line hole for inserting and connecting a first core line (+) a first feed cable transferring a first feed signal;
a first ground via hole for penetratively connecting a first ground line (−) of the first feed cable;
a first balun hole for inserting and connecting a first balun cable which forms a pair with the first feed cable in parallel to serve as a balun;
a second core line hole for inserting and connecting a second core line (+) of a second feed cable transferring a second feed signal;
a second balun hole for inserting and connecting a second balun cable which forms a pair with the second feed cable in parallel to serve as the balun; and
a core line balun connection via hole for penetratively connecting the second balun cable with the second core line (+).

2. The antenna radiation board of claim 1, wherein dipole antennas are provided on a front surface and a rear surface and a feed signal is provided through a via hole to each dipole antenna at the same time.

3. The antenna radiation board of claim 2, wherein parasite elements for extending a frequency band of each dipole antenna are provided on the front surface and the rear surface.

4. An antenna radiation board, comprising:
a front surface with a front dipole antenna radiating a first feed signal;
a rear surface with a rear dipole antenna radiating a second feed signal;
a feeding part providing the first feed signal to the front surface and providing the second feed signal to the rear surface through a via hole; and
a feed line part transferring the first feed signal from the feeding part to the front dipole antenna and transferring the second feed signal to the rear dipole antenna.

5. The antenna radiation board of claim 4, wherein the feeding part includes a front feeding part receiving the first feed signal and a rear feeding part receiving the second feed signal, and
the feeding part includes:
a first core line hole through which a first core line (+) of a first feed cable applying the first feed signal is penetratively connected from the rear feeding part;
a first ground via hole to which a first ground line (−) of the first feed cable is penetratively connected from the rear feeding part;
a first balun hole into which a first balun cable which forms a pair with the first feed cable to serve as a balun is inserted and connected;
a second core line hole into which a second core line (+) of the second feed cable is inserted and connected;
a second balun hole into which a second balun cable which forms a pair with the second feed cable to serve as the balun is inserted and connected; and
a core line balun connection via hole for connecting the second balun cable with the second core line (+) by penetrating the front feeding part and the rear feeding part.

6. The antenna radiation board of claim 5, wherein the core line balun connection via hole and the second balun hole are connected to each other through is connection pattern, and the second feed signal applied to the second core line hole of the front feeding part by penetrating from the second core line hole of the rear feeding part is transferred to the core line balun connection via hole through the connection pattern and is transferred to the core line balun connection via hole of the rear feeding part by penetrating from the core line balun connection via hole of the front feeding part.

7. The antenna radiation board of claim 5, wherein in the front feeding part, the first core line hole and the first balun hole are connected to each other through a first printed circuit pattern, and
the first feed signal applied to the first core line hole of the front feeding part by penetrating the first core line hole from the rear feeding part is transferred to the first balun hole through the printed circuit pattern.

8. The antenna radiation board of claim 4, wherein parasite elements for extending frequency bands of the front dipole antenna and the rear dipole antenna are provided on the front surface and the rear surface.

9. The antenna radiation board of claim 4, wherein the front dipole antenna radiates a polarized wave of +45° and the rear dipole antenna radiates a polarized wave of −45°.

10. A board-type dual polarization dipole antenna, comprising:
a first feed cable transferring a first feed signal;
a first balun cable which forms a pair with the first feed cable to serve as a balun;
a second feed cable transferring the first feed signal and a second feed signal;
a second balun cable which forms a pair with the second feed cable to serve as the balun;
a support unit fixing and supporting the first feed cable and the first balun cable and the second feed cable and the second balun cable; and
a radiation board in which the first feed cable, the first balun cable, the second feed cable and the second balun cable are inserted and connected and dipole antennas are provided on a front surface and a rear surface to radiate the first feed signal as a first polarized wave through the dipole antenna provided on the front surface and radiate the second feed signal as a second polarized wave vertical to the first polarized wave through the dipole antenna provided on the rear surface.

11. The board-type dual polarization dipole antenna of claim 10, wherein the radiation board includes:
a feeding part providing the first feed signal from the first feed cable to the front surface and providing the second feed signal from the second feed cable to the rear surface; and
a feed line part transferring the first feed signal from the feeding part to the dipole antenna provided on the front surface and transferring the second fed signal to the dipole antenna provided on the rear surface.

12. The board-type dual polarization dipole antenna of claim 11, wherein the feeding part includes:
a first core line hole through which a first core line (+) of the first feed cable is inserted and connected;
a first ground via hole to which a first ground line (−) of the first feed cable is penetratively connected;
a first balun hole into which a first balun cable which forms a pair with the first feed cable to serve as a balun is inserted and connected;
a second core line hole into which a second core line (+) of the second feed cable is inserted and connected;
a second balun hole into which a second balun cable which forms a pair with the second feed cable to serve as the balun is inserted and connected; and
a core line balun connection via hole for connecting the second balun cable with the second core line (+) by penetrating the front surface and the rear surface.

13. The board-type dual polarization dipole antenna of claim 12, wherein on the front surface of the radiation board, the first core line hole and the first balun hole are connected to each other through a first printed circuit pattern, the second core line hole and the core line balun connection via hole are connected to each other by a connection pattern, and on the rear surface of the radiation board, the core line balun connection via hole and the second balun hole are connected to each other by a second printed circuit pattern.

14. The board-type dual polarization dipole antenna of claim 12, wherein the first feed signal is transferred from the first core line hole to the first balun hole through the first printed circuit pattern and is transferred to the dipole antenna provided on the front surface from the first balun hole through the feed line part.

15. The board-type dual polarization dipole antenna of claim 12, wherein the second feed signal penetrates from the second core line hole to be transferred to the second core line hole of the front surface, is transferred to the core line balun connection via hole of the front surface from the second core line hole of the front surface through the connection pattern, penetrates from the core line balun connection via hole of the front surface to be transferred to a core line balun connection via hole of the rear surface, is transferred to the second balun hole from the core line balun connection via hole through the second printed circuit pattern, and is transferred to the dipole antenna provided on the rear surface from the second balun hole through the feed line part.

16. The board-type dual polarization dipole antenna of claim 13, wherein on the radiation board, parasite elements for extending frequency bands of the dipole antenna provided on the front surface and the dipole antenna provided on the rear surface are provided on the front surface and the rear surface.
